(19) United States
(12) Patent Application Publication
(10) Pub. No.: US 2024/0390978 A1
(43) Pub. Date: Nov. 28, 2024

(54) ARCHITECTED THREE-DIMENSIONAL POROUS MATERIAL

(71) Applicant: ORIGINAL CUSTOM COMPONENTS, Nîmes (FR)

(72) Inventors: Stéphane ESCALIER, Sussargues (FR); Isabelle ESCALIER, Sussargues (FR)

(21) Appl. No.: 18/690,947

(22) PCT Filed: Sep. 13, 2022
(86) PCT No.: PCT/EP2022/075388

§ 371 Date: Mar. 11, 2024

(30) Foreign Application Priority Data
Sep. 13, 2021 (FR) FR2109568

(51) Int. Cl. B22F 10/28; B22F 10/60; B33Y 10/00; B33Y 70/00; B33Y 80/00

(52) U.S. Cl. CPC B22F 10/28; B22F 10/60; B33Y 10/00; B33Y 70/00; B33Y 80/00

(57) ABSTRACT

An architected three-dimensional material including a set of elementary patterns forming a one-piece structure is disclosed. Each of the patterns has a three-dimensional structure. At least one pattern has a hollow three-dimensional structure and includes at least one hole by means of which a cavity in the at least one pattern is connected to the exterior of the at least one pattern.

### TECHNICAL FIELD

The present invention relates to the field of architected three-dimensional materials. These materials are also known by the name lattice structure.

The invention also relates, in particular, to architected three-dimensional materials of the “foam” type. The invention is also targeted, in particular but not solely, at architected three-dimensional metallic materials and/or architected three-dimensional composite materials.

### STATE OF THE PRIOR ART

Stochastic foams which have a random three-dimensional structure and regular foams which have a regular three-dimensional structure are known from the state of the prior art. The foams can comprise open pores forming a network of interconnected pores or closed pores forming a set of individual pores isolated from each other.

Foams with open pores are called “open-cell foams”. They have a very high porosity, in which between 75% and 95% of the volume is composed of empty space. When it is metallic, this type of foam is for the most part constructed by foundry or metallurgy methods from powders and by moulding. This type of method has a very high reproducibility and makes it possible to obtain regular three-dimensional structures, but the production cost for open-cell foams by means of such methods is very high.

Foams with closed pores are called “closed-cell foams”. When it is metallic, this type of foam is for the most part manufactured by foundry from a molten metal by injection of a gas via a porous plug, by addition of a foaming agent or by infiltration of a preform or a lost pattern mould. Injection does not make it possible to obtain regular structures and it is difficult to control, which has an impact on the reproducibility of the method and/or on the regularity of the structures obtained. Addition of foaming agent does not make it possible to obtain regular structures and makes the control of the porosity difficult to manage. Infiltration of a preform makes it possible to obtain regular structures at low costs but with a reduced level of porosity. Infiltration of a lost pattern mould makes it possible to obtain regular structures with a high level of porosity but has a very high production cost.

An aim of the invention is in particular:
to propose a material having a regular three-dimensional structure, called architected material, and a method for manufacturing such an architected material,
to propose an architected material the production cost of which is low or moderate, and/or
to propose an architected porous material, and/or
to propose an architected composite material, and/or
to propose an architected material having a porosity of the order of 80% or lower,
to propose a method for manufacturing an architected material according to the invention which is highly reproducible, and/or
to propose a manufacturing method making it possible to obtain an architected material according to the invention having a geometry close to the final geometry (net-shape or near-shape), and/or
to propose a manufacturing method making it possible to obtain an architected material according to the invention not requiring a subsequent machining step, and/or
to propose a light architected material, for example with a ratio between the density of the architected material and the density of the raw, non-architected, material which is smaller than 0.5, typically smaller than or equal to 0.2, and/or
to propose an architected material having heat transfer and/or dissipation properties, and/or
to propose an architected material having energy dissipation and/or absorption properties, and/or
to propose an architected material having acoustic and/or mechanical vibration properties, in particular absorption properties, and/or
to propose a rigid architected material, for example having a Young's modulus higher than 10,000 MPa and/or an elastic limit higher than 30 MPa, and/or
to propose an architected material having a high resilience, for example having a resilience doubled compared with the material(s) constituting the structured material and/or
to propose an architected material having a high plastic deformation, in particular under compression, for example doubled compared with the material(s) constituting the structured material.

### PRESENTATION OF THE INVENTION

To this end, an architected three-dimensional material, called architected material, is proposed which comprises a set of unit cells, called cells, forming a one-piece structure, each, preferably all, of the cells has, or forms or constitutes, a three-dimensional structure and at least one cell has a hollow three-dimensional structure and comprises at least one orifice through which a cavity of the at least one cell communicates with the outside of the at least one cell.

The cells can be different from each other.

One portion of the cells can be identical to at least one other portion of the cells.

Preferably, all the cells are identical to each other.

Preferably, a cell can be symmetrical or can have a geometric shape having a symmetry.

Preferably, the cells are capable of being, preferably arranged to be, deformed, both elastically and plastically according to the envisaged application, by applying a mechanical stress to the material. Preferably, the cells are capable of being, preferably arranged to be, deformed, preferably plastically, by applying a mechanical stress to the material. Preferably, the cells are capable of being, preferably arranged to be, deformed plastically according to the application envisaged, by applying a mechanical stress to the material.

Preferably, the cells are capable of dissipating and absorbing, preferably arranged to dissipate and absorb, mechanical vibrations and/or a mechanical stress and/or energy, in particular mechanical energy (vibrations and/or mechanical shocks and/or shock waves, etc.).

Preferably, a person skilled in the art will directly deduce that the cavity forms a hollow volume of the hollow three-dimensional structure which communicates with the outside of the at least one cell via the at least one orifice.

Preferably, the cells are connected to each other.

Preferably, the one-piece structure constitutes the architected material.

By one-piece structure may be meant a structure, a material or a part made of a single block or a single piece.

The architected material can be constituted by a single chemical element or a plurality of different chemical elements.

By three-dimensional structure may be meant a structure having a particular shape or geometry. The cell can be a three-dimensional geometric structure.

Each cell can have a three-dimensional structure different from a three-dimensional structure of each of the other cells or several of the other cells or one other cell.

A portion of the cells can have an identical geometric structure.

All the cells can have one and the same geometric structure.

Preferably, a plurality of cells have a hollow three-dimensional structure.

More preferably, each of the cells of the architected material has a hollow three-dimensional structure.

A cell can have a geometry that is regular or not, for example polyhedral, preferably a spherical, pyramidal, octahedral or dodecahedral geometry.

The at least one cell can comprise a single orifice.

The at least one cell can comprise several orifices.

The at least one cell having a hollow three-dimensional structure can be a plurality of cells or a set of cells.

Preferably, each of the cells of the set of unit cells has a hollow three-dimensional structure. Preferably, each of the cells of the set of unit cells comprises at least one orifice.

Preferably, the architected material comprises several cells having a hollow three-dimensional structure and comprising at least one orifice.

Preferably, each cell of the architected material has a hollow three-dimensional structure and comprises at least one orifice.

Preferably, the architected material has a regular structure. More preferably, the architected material has a symmetry.

Preferably, several cells, or respectively each of the cells, have a hollow three-dimensional structure and comprise at least one orifice and each of the central axes and/or axes of revolution of the orifices is oriented in one and the same direction.

Preferably, the at least one orifice constitutes an opening between the inside and the outside of the cell, i.e. between the inside and the outside of the hollow three-dimensional structure.

Preferably, the at least one orifice is provided in a wall of the at least one cell.

Preferably, the cavity of the at least one cell is delimited or circumscribed by an inner surface of the wall of the at least one cell.

Preferably, the wall of the at least one cell forms or constitutes the hollow three-dimensional structure of the cells.

A ratio between a dimension of the at least one orifice and a minimum Feret diameter of the at least one cell can be smaller than or equal to 0.35, preferably than or to 0.3, more preferably than or to 0.25, preferably than or to 0.2, more preferably than or to 0.15 and even more preferably than or to 0.1.

Preferably, the dimension of the at least one orifice is the minimum dimension of the at least one orifice and/or is a minimum Feret diameter of the at least one orifice.

Preferably, a person skilled in the art will directly deduce that the ratio between a minimum dimension of the at least one orifice and a minimum Feret diameter of the at least one cell defines or means that the dimension or the diameter of the at least one orifice is small, preferably at least three times smaller than the dimension or the diameter of the cavity of the at least one cell.

Preferably, a person skilled in the art will directly deduce that the minimum dimension of the at least one orifice is, for example:
if the at least one orifice is a circle: the diameter of the circle,
if the at least one orifice is an ellipse: the semi-minor axis of the ellipse,
if the at least one orifice is a square: the length of the sides of the square,
if the at least one orifice is a rectangle: the width of the rectangle.

Several of the cells, preferably each of the cells, can comprise at least one orifice.

The material can comprise:
a support structure connecting, to each other, at least two cells adjoining and/or facing each other, and/or
at least one junction area connecting two cells adjoining and/or facing each other, said junction area being common to said two cells adjoining and/or facing each other.

The one-piece structure, or the architected material, is formed by:
the at least one junction area and the set of cells and/or
the support structure and the set of cells.

The support structure, preferably taken as a whole, can be, or can have a geometry, of the foam or lattice type.

Preferably, the support structure can be symmetrical or can have a geometry having a symmetry.

The support structure can comprise, or preferably be constituted by, a set of elements or rods; a rod extending between two adjoining cells 2. Preferably, each of the cells is connected to each of the cells which adjoin it, and/or which face it, by elements or rods of the support structure. The elements or the rods of the support structure can have any shape whatever, for example a straight or rectilinear shape or a curved shape or a Z shape.

Preferably, the support structure and/or the at least one junction area connects a plurality of cells to the adjoining cells which each of the cells, of the plurality of cells, faces in order to form a mesh or a network.

Even more preferably, the support structure and/or the at least one junction area connects each cell to the adjoining cells which it adjoins and/or faces in order to form a mesh or a network.

Preferably, the two cells adjoining and/or facing each other connected by the at least one junction area are placed side by side and/or have a common portion and/or are connected directly and/or physically.

Preferably, the two cells adjoining and/or facing each other connected by the at least one junction area are in contact at the level of the common portion.

Preferably, one, several or each of the orifices of the architected material are located at the level of junction areas. Preferably, one, several or each of the cells each comprise at least two, preferably two, orifices. Preferably, for a given cell, the orifice is common to the two cells adjoining and/or facing each other.

The support structure can be arranged to form a geometric network. Preferably, the support structure can be arranged to form a regular network.

The material can comprise a reinforcing structure, the reinforcing structure comprises or forms at least one strip or bar or rod, the reinforcing structure and/or the at least one strip:
extends between two opposite external walls of the architected material, and/or
forms (an) internal partition(s), preferably within the at least one cell and/or the cavity, and/or
is arranged to reinforce the architected material, preferably the area of the architected material located between the two areas between which the reinforcing structure extends, for example between the two opposite external walls of the architected material.

The at least one strip can be rectilinear or curved.

The at least one strip can extend through or within the at least one cell and/or the at least one cavity and/or the support structure and/or the junction area. Preferably, the at least one strip does not extend through and does not obstruct the at least one orifice.

Preferably, at least one strip is located on an end face of the architected material. Preferably, at least one strip extending within the architected material.

The at least one strip can be arranged to allow the flow of gas inside the architected material and/or to remove gas from (a) given area(s) of the architected material and convey it to one or more other areas of the architected material and/or to facilitate the flow of gas from (a) given area(s) of the architected material to one or more other areas of the architected material.

The architected material can be a porous material and/or a composite material in which at least a portion of a volume, called void volume, preferably the void volume as a whole, extending or comprised or formed by the space located between the cells and/or between the cells and the support structure and/or in the cavity of the at least one cell comprises, or is constituted by:
a matrix, and/or
at least one pore.
   In other words, the architected material can be:
an architected composite non-porous material in which the void volume comprises solely, or is constituted by, the matrix; or, in other words, in which the matrix constitutes the void volume, or
an architected porous material without a matrix in which the void volume comprises solely, or is constituted by, the at least one pore and does not comprise a matrix; or, in other words, in which the at least one pore constitutes the void volume, or
an architected composite porous material in which the void volume comprises the matrix and the at least one pore; or, in other words, in which the matrix and the at least one pore constitute the void volume.

In the present application, by architected porous material may be meant a material comprising the at least one pore.

In the present application, by architected porous material may be meant:
an architected porous material without a matrix, or
an architected porous composite material comprising the matrix and the at least one pore.

Preferably, by composite material is meant a material in which the matrix has a composition different from the composition of the at least one cell and/or of the support structure and/or of several cells or of each of the cells. By “different composition” may be meant to be constituted by a different element or to comprise (a) different element(s).

Preferably, the void volume and/or the at least one pore extends, at least, between the at least one orifice, and therefore the cavity, and the periphery, of the edges, of the sides and/or of the contours of the architected material. Preferably, the at least one orifice, and therefore the cavity, and the outside of the architected porous material communicate via the void volume and/or the at least one pore.

Preferably, the void volume is comprised within the architected material. Preferably, the void volume is comprised solely within the architected material. Preferably, the void volume does not extend to the outside of the architected material. Preferably, the void volume does not extend beyond the periphery, the edges, the sides and/or the contours of the architected material.

Preferably, by “between the cells” is meant the volume located on the outside of the cells or the external volume of the cells or the volume extending between the external surfaces of the walls of the cells.

Preferably, by “between the cells and the support structure” is meant the volume located on the outside of the cells and of the support structure, or the volume outside the cells and the support structure or the volume extending between the external surfaces of the walls of the cells and the external surfaces of the walls of the support structure.

The at least one pore can comprise or constitute or form a set or a plurality of pores or a porous volume or a porous network or porous space. One, a plurality or all of the pores can communicate with each other. The pores can be isolated from each other. Preferably, the pores are interconnected and, more preferably, can form a porous network.

More preferably, the void volume forms a network extending within the architected material. Even more preferably, the void volume forms a network extending within the whole of the architected material. Even more preferably still, the void volume forms a network extending homogeneously and/or symmetrically within the architected material.

The architected porous material can be an architected material with open pores or with closed pores.

Preferably, the architected porous architected material according to the invention has a porosity greater than 40%, more preferably than 50%, even more preferably than 60%, even more preferably still than 70%, particularly preferably than 75% and most preferably than 80%.

The void volume can be defined by a space which is delimited or circumscribed by external surfaces of cells and/or external surfaces of the support structure.

Preferably, the void volume extends, at least in part, to the outside of the at least one cell.

Preferably, the void volume envelops, at least in part, preferably in part, the at least one cell.

Preferably, the void volume extends to the outside of at least one cell, preferably of several cells.

Preferably, the void volume is formed or delimited or circumscribed by the external surfaces of several cells. More preferably, the void volume is formed or delimited or circumscribed by the external surfaces of several facing and/or adjoining cells.

The void volume can be arranged to form a regular network.

The cells can be arranged with respect to each other to form a regular network. In the present application, by “regular” may be meant organized or structured.

Preferably, the cells are arranged with respect to each other or the void volume is arranged or the support structure is arranged or the matrix is arranged to form, preferably in each case, a regular network, preferably a distinct regular network.

Preferably, the cells are arranged with respect to the at least one pore, or vice versa, and/or with respect to the support structure, or vice versa, and/or with respect to the void volume, or vice versa, and/or with respect to the support structure, or vice versa, and/or the at least one pore is arranged with respect to the support structure, or vice versa, and/or with respect to the void volume, or vice versa, and/or with respect to the matrix, or vice versa, and/or the support structure is arranged with respect to the void volume, or vice versa, and/or with respect to the matrix, or vice versa, and/or the void volume is arranged with respect to the matrix, or vice versa, to each form a regular network, preferably a distinct regular network.

Preferably, the at least one pore is arranged according to a regular network that complements the regular network according to which the cells are arranged and/or the regular network according to which the void volume is arranged and/or the regular network according to which the support structure is arranged.

A regular network can be symmetrical or can have a geometry having a symmetry or can extend within the architected material in a symmetrical manner.

The material can comprise at least one link arranged in order that the cavity of a given cell communicates with the cavity of a cell adjoining and/or located facing said given cell.

Preferably, the material comprises a plurality of links, through which each of the cavities of a plurality of cells communicates with the cavities of several other cells adjoining and/or located facing the cell.

Preferably, for a given cavity, the cavity is connected to each of the cavities of each of the cells adjoining and/or located facing the cell comprising the given cavity.

Preferably, the at least one link is:
at least one duct formed by, or corresponding to, at least a portion of the support structure and connecting, to each other, two cells adjoining and/or facing each other, and/or
an opening located or comprised within the junction area connecting the two adjoining and/or facing cells and through which the two cavities of the two adjoining and/or facing cells communicate.

The cell adjoining and/or located facing said given cell can be the at least one cell having a hollow three-dimensional structure and comprising the at least one orifice.

Preferably, the cavity of the given cell communicates with the at least one cell directly, via the at least one link, or indirectly, via a set of adjoining and/or facing cavities connected in twos by a link.

The architected material can be an architected porous material, preferably without a matrix, in which the cells, or the cells and the support structure, comprise, or are constituted by, one or more metallic elements or one or more polymers.

By “element” may be meant a chemical element.

A metallic element can be iron, aluminium, titanium, cobalt, manganese, chromium or nickel. Several metallic elements can form an alloy. The alloy can comprise non-metallic elements. Preferably, the metallic element(s) are weldable. The architected porous material can be an aluminium alloy, a titanium-based alloy or a nickel-based alloy. Preferably, the architected porous material comprises or is composed of an alloy known as light.

A polymer can be polyethylene, polyester, polypropylene, polyurethane, poly (vinyl chloride) (PVC), polyamide and/or polystyrene. More preferably, the polymer can be polyethylene terephthalate (PET). Preferably, the polymer can be high-molecular-weight polyethylene (HMWPE) or ultra-high-molecular-weight polyethylene (UHMWPE).

The architected material can be an architected composite porous or non-porous material in which the cells, or the cells and the support structure, comprise, or are constituted by, one or more metallic elements and in which the matrix comprises, or is constituted by, one or more metallic elements or one or more polymers.

The architected material can be a metal foam or a composite metal foam.

The architected material can be a semi-closed-cell metal foam.

According to the invention, it is also proposed to use the material for its heat transfer and/or dissipation properties.

According to the invention, it is also proposed to use the material for its properties for dissipating and/or absorbing energy and in particular mechanical energy.

According to the invention, it is also proposed to use the material for its plastic deformation properties.

According to the invention, it is also proposed to use the material for its sound absorption, and in particular sound reduction, properties.

According to the invention, it is also proposed to use the material for its ductility and/or its resilience and/or its rigidity in the elastic and/or plastic ranges.

According to the invention, a method for constructing, or manufacturing, an architected three-dimensional material according to the invention is also proposed, the method comprising the steps consisting of:
forming, by additive manufacturing from a base material, a set of unit cells, called cells, forming a one-piece three-dimensional structure, of which at least one cell comprises at least one orifice through which a cavity of the at least one cell communicates with the outside of the at least one cell,
preferably subsequently to the step of forming the cells, discharging the base material, preferably contained in the at least one cell, to the outside of the at least one cell through the at least one orifice in order to obtain at least one cell having a hollow three-dimensional structure.

The method can comprise, among other things, the step consisting of forming, by additive manufacturing from a base material, which can be identical to or different from the base material used to form the cells:
a support structure connecting, to each other, at least two cells adjoining and/or facing each other, and/or
a junction area connecting two cells adjoining and/or facing each other, said junction area being common to said two cells adjoining and/or facing each other.

The method can comprise, or the discharging step can comprise, moreover, the steps, or respectively the sub-steps, consisting of:
discharging base material contained, preferably after implementation of the step of forming the cells and/or the support structure and/or the junction area, in a given cell, preferably having a hollow 3D structure, through at least one link arranged in order that the cavity of the given cell communicates with the at least one cell directly or indirectly, for example via a set of cavities connected in twos by a link, then discharging the base material, which has previously been discharged from the given cell, from the architected material through the at least one orifice of the at least one cell through which the cavity of the at least one cell and the outside of the architected material communicate, or
discharging, through the at least one orifice, base material contained, preferably after implementation of the step of forming the cells and/or the support structure and/or the junction area, in the at least one cell from the cavity of the at least one cell to at least a portion of a volume, called discharge volume, extending between the cells and/or between the cells and the support structure then discharging the base material, which has previously been discharged from the at least one cell, from the architected material through the discharge volume through which the outside of the architected material and the at least one orifice of the at least one cell communicate.

When the method comprises the step consisting of discharging the base material contained in a given cell through at least one link then discharging the base material from the architected material through the at least one orifice through which the cavity of the at least one cell and the outside of the architected material communicate; the at least one orifice is comprised within or forms a portion of or is coincident with the periphery, an edge, a side and/or a contour of the architected material.

Preferably, the base material is discharged from several given cells, more preferably from each of the cells, of the given architected material.

Preferably, the step or steps consisting of discharging the base material contained in a given cell through at least one link then discharging the base material from the architected material through the at least one orifice through which the cavity of the at least one cell and the outside of the architected material communicate make it possible to obtain at least one cell having a hollow three-dimensional structure.

Preferably, the step or steps consisting of discharging, through the at least one orifice, base material contained in the at least one cell then discharging the base material from the architected material through the discharge volume make it possible to obtain at least one cell having a hollow three-dimensional structure.

Preferably, the discharge volume comprises or is, at least in part, filled with base material prior to the implementation of the discharging step(s).

Preferably, the discharge volume is a volume without base material, preferably without any solid material, after implementation of the discharging step(s).

The additive manufacturing technique can be:
metal 3D printing by laser powder bed fusion, the powder constituting the base material, and/or
a polymerization, the base material is a monomer or an oligomer or a polymer.

A ratio between a minimum dimension of the at least one orifice and a maximum Feret diameter of the grains constituting the powder can be greater than 10, preferably greater than 15 and preferably greater than 20.

The step of discharging the material, preferably discharging the base material of the at least one cell and/or discharging the base material from the architected material, can be performed by gravity and/or by suction and/or by changing the position and/or the orientation of the at least one orifice, preferably of the architected material, and/or by agitating the architected material.

The agitation of the architected material can be performed according to (a) back and forth movement(s), preferably implemented in one or more different directions, more preferably according to movements which are rapid and/or of the vibrations type, and/or according to (a) rotational movement(s).

The method can comprise the step consisting of forming a matrix in all or some of a volume, called void volume, extending between the cells and/or between the cells and the support structure and/or within the cavity of the at least one cell.

Preferably, the void volume comprises the discharge volume and the volume of the cavity of the at least one cell.

Preferably, the void volume is a volume without base material, preferably without any solid material, prior to the step consisting of forming a matrix.

Preferably, the step consisting of forming the matrix makes it possible to obtain an architected porous material and/or an architected composite material comprising a matrix and/or at least one pore.

The method can comprise, preferably prior to the implementation of the step consisting of forming the matrix, a step consisting of forming a sacrificial structure in a portion of the void volume.

Preferably, the step of forming the sacrificial layer makes it possible to fill in or block or fill up a portion of the void volume with the sacrificial structure.

The step consisting of forming the matrix can comprise, or consist of, a casting and/or an injection of a base material, which can be identical to or different from the base material used to form the cells and/or the support structure and/or the junction area, into the void volume then a polymerization and/or a solidification of the, cast and/or injected, base material, such that the, polymerized and/or solidified, base material occupies all or some of the void volume.

Preferably, the sacrificial layer can be taken away:
concurrently with the implementation of the step of forming the matrix, and/or
subsequently to the implementation of the step of casting and/or injecting the base material, or
subsequently to the implementation of the step of polymerizing and/or solidifying the base material.

The method can comprise the step consisting of forming, by additive manufacturing, preferably from the base material, a reinforcing structure comprising or forming at least one strip. One strip of the at least one strips of the architected material can form a scaffold area from which or on which the rest of the architected material is formed.

Preferably, the at least one strip of the architected material constitutes an initial or original portion. Preferably, the initial portion constitutes the first portion of the architected material which is formed.

Preferably, the reinforcing structure forms, after implementation of the method, i.e. after the manufacture of the architected material, at least one strip located on an external face or on an end of the architected material and/or at least one strip extending within the architected material.

The scaffold area can be formed prior to each of the other portions of the architected material.

The at least one portion of the reinforcing structure formed prior to each of the other steps of the method is preferably formed prior to the other steps of forming the material, for example prior to the formation of the cells and/or the support structure and/or the junction areas and/or the matrix and/or prior to the casting and/or the injection of base material.

The method according to the invention is particularly suitable for constructing, more preferably specially designed to construct, the material according to the invention. Thus, any feature of the method according to the invention can be integrated in the device according to the invention, and vice versa.

### DESCRIPTION OF THE FIGURES

Other advantages and characteristics of the invention will become apparent on reading the detailed description of non-limitative implementations and embodiments, and the following attached drawings:

FIG. 1a is a diagrammatic representation of a photograph, which is shown in FIG. 1b, of a front view of a cross section of an architected porous material according to a first embodiment according to the invention, FIG. 1b is a photograph of a front view of a cross section of an architected porous material according to a first embodiment according to the invention,

FIG. 2a is a diagrammatic representation of a photograph, which is shown in FIG. 2b, of an oblique view of a cross section of an architected porous material according to a first embodiment according to the invention, FIG. 2b is a photograph of an oblique view of a cross section of an architected porous material according to a first embodiment according to the invention,

FIG. 3a is a diagrammatic representation of a photograph, which is shown in FIG. 3b, of a side view of an oblique cross section of an architected porous material according to a first embodiment according to the invention, FIG. 3b is a photograph of a side view of an oblique cross section of an architected porous material according to a first embodiment according to the invention,

FIG. 4 is a diagrammatic representation of a photograph, which is shown in FIG. 5, of an oblique view of a cross section of an architected porous material according to a second embodiment according to the invention,

FIG. 5 is a photograph of an oblique view of a cross section of an architected porous material according to a second embodiment according to the invention.

### DESCRIPTION OF THE EMBODIMENTS

As the embodiments described hereafter are in no way limitative, it is possible in particular to consider variants of the invention comprising only a selection of the features described, in isolation from the other features described (even if this selection is isolated within a sentence comprising these other features), if this selection of features is sufficient to confer a technical advantage or to differentiate the invention with respect to the state of the prior art. This selection comprises at least one, preferably functional, feature without structural details, or with only a part of the structural details if this part alone is sufficient to confer a technical advantage or to differentiate the invention with respect to the state of the prior art.

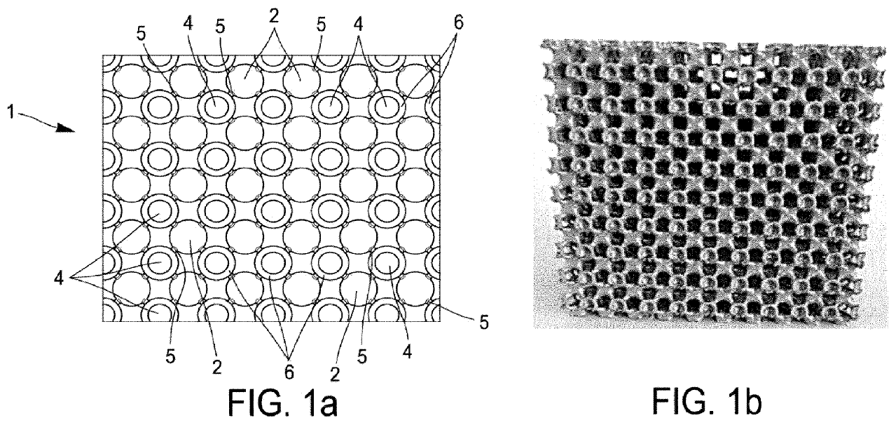

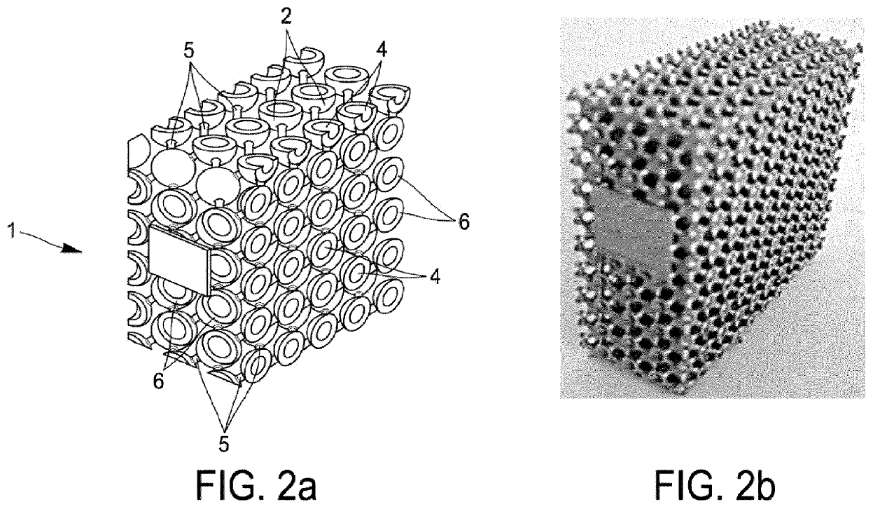

An embodiment of the architected three-dimensional material 1, called architected material 1, according to the invention is described with reference to FIGS. 1 to 5. This architected material 1 comprises a set of unit cells 2, called cells 2, forming a one-piece structure. The one-piece structure constitutes the architected material 1. Each of the cells 2 has a three-dimensional structure. At least one cell 2, each of the cells 2 according to the embodiment, has a hollow three-dimensional structure and comprises at least one orifice 3 through which a cavity 4 of the at least one cell 2 communicates with the outside of the at least one cell 2.

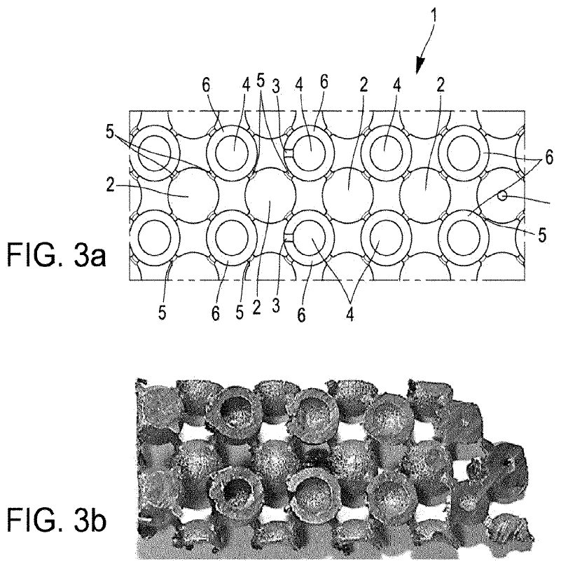

According to the embodiment shown, each of the cells 2 comprises at least one orifice 3. The orifices 3 can be seen in FIGS. 3 to 5.

The orifice 3 has the effect of decreasing the mass, or the apparent density, of the architected material 1. The orifice 3 makes it possible to obtain a light structured material 1.

The orifice 3 has the effect of increasing the void volume and/or the pore volume of the architected material 1. The orifice 3 makes it possible to increase the porosity of the architected material 1.

The orifice 3 has the effect of providing the architected material 1 with particular acoustic properties, in particular properties of absorption and/or propagation of sound waves.

The orifice 3 has the effect of providing the architected material 1 with particular mechanical vibration properties, in particular properties of absorption and/or propagation of mechanical vibrations.

The orifice 3 has the effect of improving the deformation, in particular the plastic deformation, of the structured material 1.

The orifice 3 makes it possible to obtain a structured material 1 having better energy dissipation and/or absorption.

According to the embodiment shown, the cell 2 is a sphere.

According to the embodiment shown, the architected material 1 is made of steel. In particular, the architected material 1 is made of 316L stainless steel. Architected materials made of Ta6V titanium and an IN718 nickel-based alloy have also been constructed.

Each of the cells 2 is constituted by a wall 6 forming the hollow three-dimensional structure 2. The wall 6 of the cell 2 delimits the cavity 4.

The hollow three-dimensional structure 2 has the effect of decreasing the mass, or the apparent density, of the architected material 1. The hollow three-dimensional structure 2 makes it possible to obtain a light structured material 1.

The hollow three-dimensional structure 2 has the effect of increasing the void volume and/or the discharge volume and/or the pore volume of the architected material 1. The hollow three-dimensional structure 2 makes it possible to increase the porosity of the architected material 1.

The hollow three-dimensional structure 2 makes it possible to increase the ductility of the architected material 1.

The hollow three-dimensional structure 2 makes it possible to increase the resilience of the architected material 1.

The hollow three-dimensional structure 2 has the effect of improving the deformation, in particular the plastic deformation, of the structured material 1.

The hollow three-dimensional structure 2 makes it possible to obtain a structured material 1 having better energy dissipation and/or absorption.

The hollow three-dimensional structure 2 has the effect of providing the architected material 1 with particular acoustic properties, in particular properties of absorption and/or propagation of sound waves.

The hollow three-dimensional structure 2 has the effect of providing the architected material 1 with particular mechanical vibration properties, in particular properties of absorption and/or propagation of mechanical vibrations.

The diameter of an orifice 3 is typically comprised between 0.3 and 5 mm according to the embodiment.

The diameter of the cavity 4 is typically comprised between 3 and 30 mm according to the embodiment.

The thickness of the wall 6 is typically comprised between 0.5 and 5 mm according to the embodiment.

The distance between two adjoining cells 2 connected to each other is typically comprised between 0 (cells 2 placed side by side at the level of the junction area 7) and 50 μm according to the embodiment, and/or typically between 3 and 50 mm (when two adjoining cells 2 are connected by a support structure 5).

The ratio between the minimum dimension of the at least one orifice 3 and the minimum Feret diameter of the at least one cell 2 is smaller than or equal to 0.35. According to the embodiment, the ratio between the minimum dimension of the at least one orifice 3 and the minimum Feret diameter of the at least one cell 2 is typically comprised between 0.1 and 0.35.

The cells 2 are arranged with respect to each other to form a regular network.

The architected material 1 is a porous material. According to the embodiment, the architected material 1 is a metal foam. The pores form a porous network, or volume. The porous network is a regular network.

According to a first variant of the embodiment, which can be combined with the second variant described below, shown in FIGS. 1 to 3, the architected material 1 comprises a support structure 5 connecting, to each other, two cells 2 adjoining and facing each other. According to the embodiment, each of the cells 2 is connected, by the support structure 5, to eight adjoining (or adjacent or neighbouring) cells 2 which it faces. For a given cell, the eight cells 2, connected to the given cell via the support structure 5, are located equidistant from the given cell 2. For a given cell, the eight cells 2, connected to the given cell via the support structure 5, are the adjoining cells 2 closest to the given cell 2. The support structure 5 is constituted by a set of elements 5 or rods 5. The rods 5 connect a given cell 2 to the eight adjoining cells 2 located equidistant from the given cell 2. Each rod 5 extends between the wall 6 of a cell 2 and the wall 6 of an adjacent cell 2. The set of rods 5 and the set of walls 6 form a one-piece assembly forming the architected material 1 according to the embodiment.

According to the first variant, and as illustrated in FIG. 3, each cell 2 comprises an orifice 3.

According to the first variant, the architected material 1 has a network or a centred cubic structure. In other words, the cells 2 occupy the tops and the centre of a cube which forms the architected material 1 by periodic translation in the three spatial directions.

The volume, called void volume, extending between the cells 2 and between the cells 2 and the support structure 5 and within the cavity 4 of the cells 2 forms a set of pores. The pores are interconnected.

The diameter of the orifice 3 is comprised between 0.3 and 5 mm according to the first variant.

The diameter of the cavity 4 is comprised between 3 and 30 mm according to the first variant.

Preferably, the thickness of the wall 6 is comprised between 0.5 and 5 mm according to the first variant.

Preferably, the distance between two cells 2 connected by a rod 5, i.e. the length of a rod 5, is comprised between 3 and 50 mm according to the first variant.

The support structure 5, and in particular the support structure 5 comprising a set of rods 5, has the effect of decreasing the mass, or the apparent density, of the architected material 1. The support structure 5, and in particular the support structure 5 comprising a set of rods 5, makes it possible to obtain a light structured material 1.

The support structure 5, and in particular the support structure 5 comprising a set of rods 5, has the effect of increasing the void volume and/or the discharge volume and/or the pore volume of the architected material 1. The support structure 5 makes it possible to increase the porosity of the architected material 1.

The support structure 5 makes it possible to increase the ductility of the architected material 1.

The support structure 5 makes it possible to increase the resilience of the architected material 1.

The support structure 5 has the effect of improving the deformation, in particular the plastic deformation, of the structured material 1.

The support structure 5 makes it possible to obtain a structured material 1 having better energy dissipation and/or absorption.

The support structure 5 has the effect of providing the architected material 1 with particular acoustic properties, in particular properties of absorption and/or propagation of sound waves.

The support structure 5 has the effect of providing the architected material 1 with particular mechanical vibration properties, in particular properties of absorption and/or propagation of mechanical vibrations.

The support structure 5 forms a geometric network. The geometric network formed by the support structure 5 is symmetrical. The support structure 5 forms a grid pattern. A plane comprising two adjacent rods 5 cuts each cell of one and the same row and/or of one and the same plane of cells through their centres.

According to the first embodiment, the porosity of the architected material 1 is 70%.

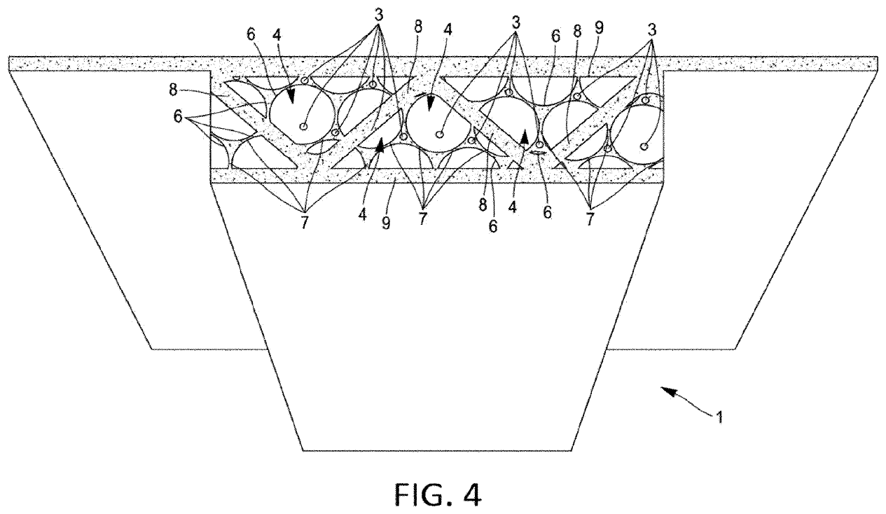

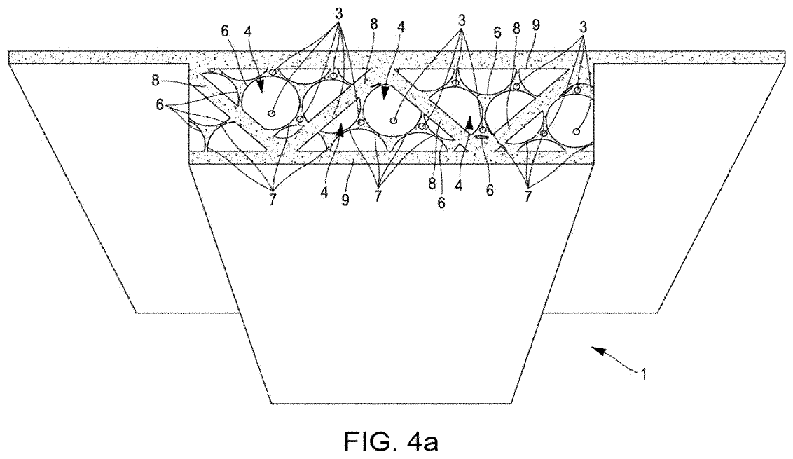

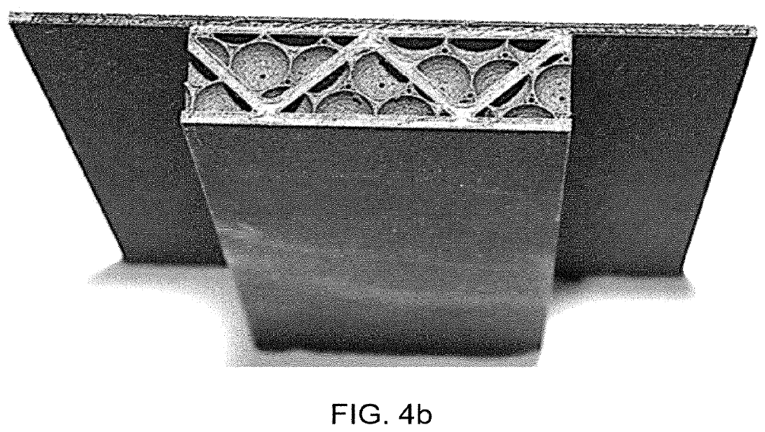

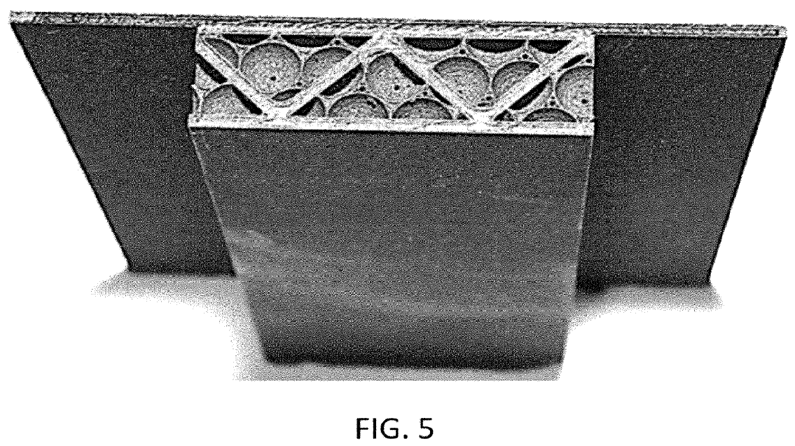

According to a second variant of the embodiment, which can be combined with the first variant described above, shown in FIGS. 4 and 5, the architected material 1 comprises at least one junction area 7 connecting two cells 2 adjoining and facing each other. The junction area 7 is common to the two cells 2 adjoining and facing each other. The orifices 3 constitute openings 4 connecting two cells 2 and are located at the level of a junction area connecting two cells 2 adjoining and facing each other. According to the embodiment, each orifice 3 is common to two cells 2 connected by a junction area 7.

According to the second variant, the architected material 1 has a 3D honeycomb structure. The 3D honeycomb structure has a face centred cubic cell. The honeycomb structure can be defined as a stack of planes of cells 2 within which the cells 2 are arranged in a honeycomb form. The periodic translation of the plane of cells 2 in one spatial direction forms the architected material 1. The centres of the cells 2, in other words the centres of the spheres 2, of a given plane of cells coincides with straight lines extending between three adjacent (neighbouring or adjoining and facing) cells of a plane of cells adjacent to (neighbouring or adjoining and facing) the given plane of cells. The straight lines extending between three adjacent cells have no intersection with any of the three facing cells 2 (nor with the walls 6 of the three adjacent cells 2).

According to the second variant, each cell 2 comprises two orifices 3 which are symmetrical with respect to the centre of the cell 2 (i.e. of the sphere 2). The straight line connecting two orifices 3 of a given cell 2 (and passing through the centre of the given cell) comprises or connects all of the orifices 3 of a row of cells 2 (along which the straight line extends).

According to the second variant, the porosity of the architected material 1 is 45%.

A plane, called median plane, perpendicular to the straight line connecting two orifices 3 of a given cell 2 and passing through the centre of the given cell 2 comprises all of the centres of the cells 2 belonging to the same plane of cells 2. The median plane of a given cell 2 comprises, among other things, three orifices 3 adjacent to the wall 6 of the given cell 2. The three orifices 3 adjacent to the wall 6 of the given cell 2 belong to the 6 cells adjacent to (neighbouring or adjoining and facing) the given cell 2. Each cell 2 is surrounded or enveloped by 6 cells abutting the given cell 2 and facing the given cell 2.

A plane perpendicular to the straight line connecting two orifices 3 of a given cell 2 and comprising one of the orifices 3 of the given cell 2 comprises one of the two orifices 3 of each cell 2 belonging to the same plane of cells 2.

The volume, called void volume, extending between the cavities 4 through the orifices 3, or, in other words, formed by the cavities 4 and the orifices 3, forms a set of pores. The pores are interconnected. For a given cell 2, the cavity 4 of the given cell 2 communicates, via its two orifices 3, with the cavities 4 of the two (facing and neighbouring or adjoining or adjacent) cells 2 of the row of cells 2 with which the given cell 2 is connected via its two orifices 3.

A spatial direction, among other things, in which the periodic translation of a plane of cells 2 forms the architected material 1 is the direction connecting an orifice 3 of a given cell 2 of a given row of cells 2 to an orifice 3 of a cell 2 adjoining (or neighbouring or adjacent) and facing the given cell 2 of a row of cells 2 adjoining (or neighbouring or adjacent) and facing the given row of cells.

Preferably, the diameter of the orifice 3 is comprised between 0.3 and 5 mm according to the second variant.

Preferably, the diameter of the cavity 4 is comprised between 3 and 30 mm according to the second variant.

Preferably, the thickness of the wall 6 is comprised between 0.5 and 5 mm according to the second variant.

Preferably, the distance between two cells 2 is 0 mm because the junction area 7 is common to the two cells 2 adjoining and facing each other and forms the wall of the two cells 2 adjoining and facing each other.

The junction area 7 makes it possible to increase the rigidity of the architected material 1. The junction area 7 also makes it possible to increase the thermal and electrical conductivity because of the improvement of the link between two cells 2. The junction area 7 also makes it possible to change the angle of incidence of a wave or an object penetrating into the architected material 1.

The architected material 1 according to the embodiment is constructed by means of a method comprising the steps consisting of:
forming, by additive manufacturing from a base material, the set of cells 2 forming the one-piece three-dimensional structure 1 of which at least one cell 2, all of the cells according to the embodiment, comprises at least one orifice 3, one orifice 3 according to the embodiment, through which the cavity 4 of the at least one cell 2 communicates with the outside of the at least one cell 2, then
discharging the base material to the outside of the at least one cell 2 through the at least one orifice 3 in order to obtain at least one cell 2, each of the cells according to the embodiment, having a hollow three-dimensional structure.

The additive manufacturing technique used according to the embodiment is 3D printing. According to the embodiment, it is metal 3D printing by laser powder bed fusion, the powder constituting the base material. The printer used is an SLM 280 printer from SLM Solutions. For the materials 1 made of Ta6V titanium and made of IN718 nickel-based alloy, an EOS290 printer from EOS and Concept Laser M2 printer from GE Additive were used.

The powder is 316L steel, the grain size of which is comprised between 10 and 100 μm.

The ratio between the minimum dimension of an orifice 3 and the maximum Feret diameter of the grains constituting the powder is greater than 10. According to the embodiment, the ratio between the minimum dimension of an orifice 3 and the maximum Feret diameter of the grains constituting the powder is comprised between 0.1 and 0.35. According to the embodiment, the orifice has a circular or disc shape, the minimum dimension of the orifice 3 therefore constitutes the diameter of the orifice 3.

In the case of the first variant of the embodiment of the architected material 1 shown in FIGS. 1 to 3, the additive manufacturing comprises, moreover, the step consisting of forming, by additive manufacturing from the base material, the support structure 5 connecting, to each other, two cells 2 adjoining and facing each other.

In the case of the second variant of the embodiment of the architected material 1 shown in FIGS. 4 and 5, the additive manufacturing comprises the step consisting of forming, from a base material, the junction area 7 connecting two cells 2 adjoining and facing each other.

In the case of the second variant, the architected material 1 comprises a reinforcing structure 8 forming a strip extending within the architected material. The strip is constituted by several rectilinear portions forming a Z-shaped structure according to the embodiment. However, the strip can also have a curved shape. The reinforcing structure 8, and in particular each of the rectilinear portions of the reinforcing structure 8, extends between two opposite external walls 9 of the architected material 1. The strip can be tilted with respect to the opposite external walls 9 of the architected material 1. According to the embodiment, the strip extends within a plane perpendicular to the opposite external walls 9 of the architected material 1. The reinforcing structure 8, and in particular each of the rectilinear portions of the reinforcing structure 8, forms internal partitions, and in particular partitions within the cells 2. The partitions formed by the reinforcing structure 8 extend, at least in part, within the cavity 4.

The reinforcing structure 8 is arranged to reinforce the architected material 1 and in particular the area of the architected material 1 located between the two areas between which the rectilinear portions of the reinforcing structure 8 extend. According to the embodiment, the reinforcing structure 8 is arranged to reinforce the architected material 1 in the direction extending between the two opposite external walls 9 of the architected material 1.

The method comprises the step consisting of forming, by additive manufacturing and from the base material, a reinforcing structure 8 forming a strip 8. The strip 8 is the part, portion or piece of the architected material 1 deposited first. It forms a scaffold area 8 for the formation of the rest of the architected material 1. The scaffold area 8 is located on an external face of the architected material 1 after manufacture. The other portions of the architected material 1, which can include the other strips 8 located within the architected material 1, are deposited on the strip 8 subsequently, but continuing the step of forming the architected material 1 by additive manufacturing.

The method, preferably, comprises the step consisting of discharging, through the orifices 3, base material, preferably all of the base material, contained in the cells 2. The base material is discharged from the cavity 4 of the cells 2 to the volume, called discharge volume, extending between the cells 2 and between the cells 2 and the support structure 5 and in the cavity 4 of the cells 2 according to the first variant and formed by the cavities 4 and the orifices 3 of the cells 2 according to the second variant. The base material is then discharged from the architected material 1 through the discharge volume through which the outside of the architected material 1 and the orifices 3 of the cells 2 communicate.

According to the embodiment, the discharge volume corresponds to the pore volume.

According to the embodiment, the orifices 3 are made in the upper portion (i.e. the portion located upwards in the vertical direction) of the cells 2 during the additive manufacturing step. In practice, no laser fusion is performed in the area of the wall 6 of the cell 2 intended to constitute the orifice 3. According to the embodiment, this area forms a disc or a circle but could have another shape. According to the embodiment, the orifice 3 is located in the upper half-sphere (i.e. the upper half-sphere located upwards in the vertical direction) of the cell 2. According to the embodiment, for a given cell 2, the orifice 3 is located in the half-sphere extending from a horizontal plane comprising the centre of the given cell 2 (and therefore of the given sphere) to the top of the sphere located upwards (in the vertical direction) with respect to the horizontal plane comprising the centre of the given cell 2.

According to the embodiment, the step of discharging the material is performed by gravity.

Preferably, the discharging step also comprises changing the orientation of the architected material 1 (and therefore of the orifices 2). In practice, the architected material 1 is inverted or turned over such that the base material contained in the cell 2 flows out of the cells 2 through the orifices 3 then out of the architected material 1 through the pore volume.

More preferably, the discharging step also comprises agitating the architected material 1 to promote the discharge of the non-fused powder from the cell 2.

According to the first variant, the discharge is carried out from the cavity 4 of a cell 2 to the discharge volume via the orifice 3 of the cell 2 in question.

According to the second variant, the discharge is carried out from a cavity 4 of a cell to the cavity 4 of an adjacent cell 2 via the orifice 3 common to the two cells 2 in question. The powder is thus emptied out of the cavities 4 of the cells 2 passing from one cell 2 to an adjacent cell 2 when the architected material 1 is turned over. Finally, the powder is discharged from the architected material 1 through terminal or end cells 2 which communicate with the outside of the architected material 1 via one of their two orifices 3.

Of course, the invention is not limited to the examples which have just been described and numerous adjustments can be made to these examples without exceeding the scope of the invention.

Thus, in variants of the previously described embodiments, which can be combined with each other:
the architected material 1 comprises the support structure 4 connecting, to each other, the at least two cells 2 adjoining and/or facing each other and the at least one junction area connecting two cells 2 adjoining and/or facing each other, said junction area being common to said two cells 2 adjoining and/or facing each other, and/or
the architected material 1 is a composite and/or porous material, in which at least a portion of a volume, called void volume, extending between the cells 2 and/or between the cells 2 and the support structure 5 and/or within the cavity 4 of the at least one cell 2 comprises a matrix and/or at least one pore, and/or
the architected material 1 comprises at least one link arranged in order that the cavity 4 of a given cell 2 communicates with the cavity 4 of a cell 2 adjoining and/or located facing said given cell 2, and/or
the cells 2, or the cells 2 and the support structure 5, comprise, or are constituted by, one or more polymers, and/or
a cell 2 comprises several orifices 3 for improving and/or facilitating the step of discharging the powder, and/or
the architected material 1 is an architected composite porous or non-porous material 1 in which the cells 2, or the cells 2 and the support structure 5, comprise, preferably are constituted by, one or more metallic elements and in which the matrix comprises, preferably is constituted by, one or more metallic elements or one or more polymers, and/or
the additive manufacturing technique is:
   metal 3D printing by laser powder bed fusion, the powder constituting the base material, and/or
   a polymerization, the base material is a monomer or an oligomer or a polymer, and/or
the method comprises, moreover, the step consisting of forming, by additive manufacturing from a base material, the support structure 4 connecting, to each other, at least two cells 2 adjoining and/or facing each other, and the junction area connecting two cells 2 adjoining and/or facing each other, said junction area being common to said two cells 2 adjoining and/or facing each other, and/or
the method, preferably, comprises the step consisting of discharging base material, preferably all of the base material, contained in a given cell 2 through at least one link arranged in order that the cavity 4 of the given cell 2 communicates with the at least one cell 2 directly or indirectly, then discharging the base material from the architected material 1 through the at least one orifice 3 of the at least one cell 2 through which the cavity 4 of the at least one cell 2 and the outside of the architected material 1 communicate, and/or
the step of discharging the material is performed by gravity and/or by suction and/or by changing the position and/or the orientation of the at least one orifice and/or by agitating the architected material 1, and/or
the method comprises the step consisting of forming a matrix in all or some of a volume, called void volume, extending between the cells 2 and/or between the cells 2 and the support structure 5 and/or within the cavity 4 of the at least one cell 2, and/or
the step consisting of forming the matrix comprises a casting and/or an injection of a base material into the void volume then a polymerization and/or a solidification of the, cast and/or injected, base material, such that the base material, after polymerization and/or solidification, occupies all or some of the void volume, and/or
the reinforcing structure 8 comprises several strips, and/or
the reinforcing structure 8 comprises several strips parallel to each other, preferably the strips each extend in a plane perpendicular to the opposite external walls 9 of the architected material 1.

In addition, the different features, forms, variants and embodiments of the invention can be combined with each other in various combinations unless they are incompatible or mutually exclusive.

1. An architected three-dimensional material, called architected material, comprising: a set of unit cells, called cells, forming a one-piece structure, each of the cells has a three-dimensional structure; and at least one cell has a hollow three-dimensional structure and comprises at least one orifice through which a cavity of the at least one cell communicates with the outside of the at least one cell and the cavity of the at least one cell is circumscribed by an internal surface of a wall of the at least one cell in which the at least one orifice is provided; and
a ratio between a minimum dimension of the at least one orifice and a minimum Feret diameter of the at least one cell is smaller than or equal to 0.35.

2. The architected material according to claim 1, in which several of the cells, preferably each of the cells, comprise at least one orifice.

3. The architected material according to claim 1, comprising:
a support structure connecting, to each other, at least two cells adjoining and/or facing each other, and/or
at least one junction area connecting two cells adjoining and/or facing each other, said junction area being common to said two cells adjoining and/or facing each other.

4. The architected material according to claim 3, in which the support structure is arranged to form a geometric network.

5. The architected material according to claim 1, comprising a reinforcing structure, the reinforcing structure comprises at one least strip, which:
extends between two opposite external walls of the architected material, and/or
forms (an) internal partition(s), and/or
is arranged to reinforce the architected material.

6. The architected material according to claim 1, in which the architected material is a porous material and/or a composite material, and in which at least a portion of a volume, called void volume, extending between the cells and/or between the cells and the support structure and/or within the cavity of the at least one cell comprises:
a matrix, and/or
at least one pore.

7. The architected material according to claim 1, in which the void volume is arranged to form a regular network.

8. The architected material according to claim 1, in which the cells are arranged with respect to each other to form a regular network.

9. The architected material according to claim 1, comprising at least one link arranged in order that the cavity of a given cell communicates with the cavity of a cell adjoining and/or located facing said given cell.

10. The architected material according to claim 1, in which the architected material is an architected porous material in which the cells, or the cells and the support structure, comprise one or more metallic elements or one or more polymers.

11. The architected material according to claim 5, in which the architected material is an architected composite porous or non-porous material in which the cells, or the cells and the support structure, comprise one or more metallic elements and in which the matrix comprises one or more metallic elements or one or more polymers.

12. The architected material according to claim 1, in which the architected material is a metal foam.

13. A method for manufacturing an architected three-dimensional material according to claim 1, the method comprising the steps consisting of:
forming, by additive manufacturing from a base material, a set of unit cells, called cells, forming a one-piece three-dimensional structure, of which at least one cell comprises at least one orifice through which a cavity of the at least one cell communicates with the outside of the at least one cell, and the cavity of the at least one cell is circumscribed by an internal surface of a wall of the at least one cell in which the orifice is provided; a ratio between a minimum dimension of the at least one orifice and a minimum Feret diameter of the at least one cell is smaller than or equal to 0.35; and
discharging the base material to the outside of the at least one cell through the at least one orifice in order to obtain at least one cell having a hollow three-dimensional structure.

14. The method according to claim 13, comprising, among other things, the step consisting of forming, by additive manufacturing from a base material:
a support structure connecting, to each other, at least two cells adjoining and/or facing each other, and/or
a junction area connecting two cells adjoining and/or facing each other, said junction area being common to said two cells adjoining and/or facing each other.

15. The method according to claim 13, comprising, moreover, the steps consisting of:
discharging base material contained in a given cell through at least one link arranged in order that the cavity of the given cell communicates with the at least one cell directly or indirectly, then discharging the base material from the architected material through the at least one orifice of the at least one cell through which the cavity of the at least one cell and the outside of the architected material communicate, or
discharging, through the at least one orifice, base material contained in the at least one cell from the cavity of the at least one cell to at least a portion of a volume, called discharge volume, extending between the cells and/or between the cells and the support structure then discharging the base material from the architected material through the discharge volume through which the outside of the architected material and the at least one orifice of the at least one cell communicate.

16. The method according to claim 13, in which the additive manufacturing technique is:
metal 3D printing by laser powder bed fusion, the powder constituting the base material, and/or
a polymerization, the base material is a monomer or an oligomer or a polymer.

17. The method according to claim 16, in which a ratio between a minimum dimension of the at least one orifice and a maximum Feret diameter of the grains constituting the powder is greater than 10.

18. The method according to claim 13, in which the step of discharging the material is performed by gravity and/or by suction and/or by changing the position and/or the orientation of the at least one orifice and/or by agitating the architected material.

19. The method according to claim 13, comprising the step consisting of forming a matrix in all or some of a volume, called void volume, extending between the cells and/or between the cells and the support structure and/or within the cavity of the at least one cell.

20. The method according to claim 19, in which the step consisting of forming the matrix comprises a casting and/or an injection of a base material into the void volume then a polymerization and/or a solidification of the, cast and/or injected, base material, such that the base material, after polymerization and/or a solidification, occupies all or some of the void volume.

21. The method according to claim 13, comprising the step consisting of forming, by additive manufacturing, a reinforcing structure comprising at least one strip, one strip of the at least one strips of the architected material forms a scaffold area on which the rest of the architected material is formed.

22. The method according to claim 21, in which the scaffold area is formed prior to each of the other portions of the architected material.
